(19) United States
(12) Patent Application Publication
(10) Pub. No.: US 2017/0213273 A1
(43) Pub. Date: Jul. 27, 2017

(54) CUSTOMER-CENTERED TRANSPORTATION AGGREGATOR

(71) Applicant: GM GLOBAL TECHNOLOGY OPERATIONS LLC, Detroit, MI (US)

(72) Inventors: EDGAR J. DIETRICH, REDWOOD CITY, CA (US); JIM K. RAINBOLT, HASLETT, MI (US); SPENCER W. CHAMBERLAIN, STERLING HEIGHTS, MI (US)

(73) Assignee: GM GLOBAL TECHNOLOGY OPERATIONS LLC, Detroit, MI (US)

(21) Appl. No.: 15/381,976

(22) Filed: Dec. 16, 2016

Related U.S. Application Data
(60) Provisional application No. 62/287,426, filed on Jan. 26, 2016.

(51) Int. Cl. G06Q 30/06; G01C 21/34; G06Q 10/02; G06Q 30/00; G06F 17/30; G06Q 20/10

(52) U.S. Cl. CPC G06Q 30/0631; G06F 17/30867; G06Q 20/102; G06Q 10/02; G06Q 30/01; G01C 21/3423

(57) ABSTRACT

Methods and systems are provided for generating available transportation modes based on location data of a user. Methods and systems retrieve metrics relating at least to time, cost and risk of each available transportation mode. Methods and systems analyze the available transportation modes and the associated metrics based on criteria related to time, cost, and risk factors. Methods and systems determine a transportation recommendation based on the analyzing. Methods and systems output the transportation recommendation to a user electronic device.

### CROSS REFERENCE TO RELATED APPLICATIONS

This application claims the benefit of U.S. Provisional Application No. 62/287,426, filed Jan. 26, 2016, the entirety of which is hereby incorporated by reference herein.

### TECHNICAL FIELD

Embodiments of the subject matter described herein relate generally to travel and mobility services. More particularly, embodiments of the subject matter relate to techniques, systems, and technologies that provide enhanced mobility options and features to travelers.

### BACKGROUND

Navigation applications are available that allow a user to determine a route from a starting location to a destination location. These applications are generally transportation mode centric, requiring user selection of a preferred transportation mode. However, such applications may not always offer the most desirable transportation option for the user.

Accordingly, it is desirable to provide a routing engine that offers more varied routing options and thus potentially improved routing outcomes. Furthermore, other desirable features and characteristics of the present invention will become apparent from the subsequent detailed description and the appended claims, taken in conjunction with the accompanying drawings and the foregoing technical field and background.

### SUMMARY

A method is provided for generating and outputting a transportation recommendation. In one example, the method includes analyzing a plurality of different transportation options available to a user, based on criteria related to time, cost, and risk factors. The method includes generating a transportation recommendation based on the analyzing. The method includes providing an output that includes the transportation recommendation to a user electronic device.

A system is provided for determining and outputting a transportation recommendation. In one example, the system comprises modules operating on a mobility assistant server and/or a mobility assistant device. The system includes a travel requirement module for receiving a travel requirement request for a user of the mobility assistant device. The travel requirement request comprises at least one destination location. The system include a transportation modality module configured to generate available transportation modes based on a location of the user and configured to retrieve metrics relating to time, cost and risk of each available transportation mode. The system includes an analyzer module configured to analyze the available transportation modes and the associated metrics based on criteria related to time, cost, and factors such as risk to determine a transportation recommendation. The system includes an output module configured to output the transportation recommendation to a user's electronic device.

A computer-readable medium comprising processor-executable instructions is provided for determining and outputting a transportation recommendation. The instructions are configured to be executed by a processor to perform various steps. In one example, the steps include generating available transportation modes based on location data of a user. The steps include retrieving metrics relating at least to time, cost and risk of each available transportation mode. The steps include analyzing the available transportation modes and the associated metrics based on criteria related to time, cost, and risk factors. The steps include determining a transportation recommendation based on the analyzing. The steps include outputting the transportation recommendation to a user's electronic device.

### DESCRIPTION OF THE DRAWINGS

The exemplary embodiments will hereinafter be described in conjunction with the following drawing figures, wherein like numerals denote like elements, and wherein:

FIG. 1 is a block diagram of an exemplary system for providing at least one transportation recommendation, in accordance with an exemplary embodiment;

FIG. 2 is a block diagram of exemplary modules of the system of FIG. 1 that operate to provide at least one transport recommendation, in accordance with an exemplary embodiment; and

FIG. 3 is an exemplary graphical user interface for setting analysis criteria, in accordance with an exemplary embodiment;

FIG. 4 is an exemplary graphical user interface for setting analysis criteria, in accordance with an exemplary embodiment;

FIG. 5 is a flowchart of an exemplary method for setting analysis criteria, in accordance with an exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The disclosed subject matter relates to travel services. The exemplary embodiments disclosed here may utilize or leverage any of the integrated travel services, features, and functions described in U.S. Pat. No. 9,201,926, issued Dec. 1, 2015, and assigned to GM Global Technology Operations LLC (the entire content of which is incorporated by reference herein).

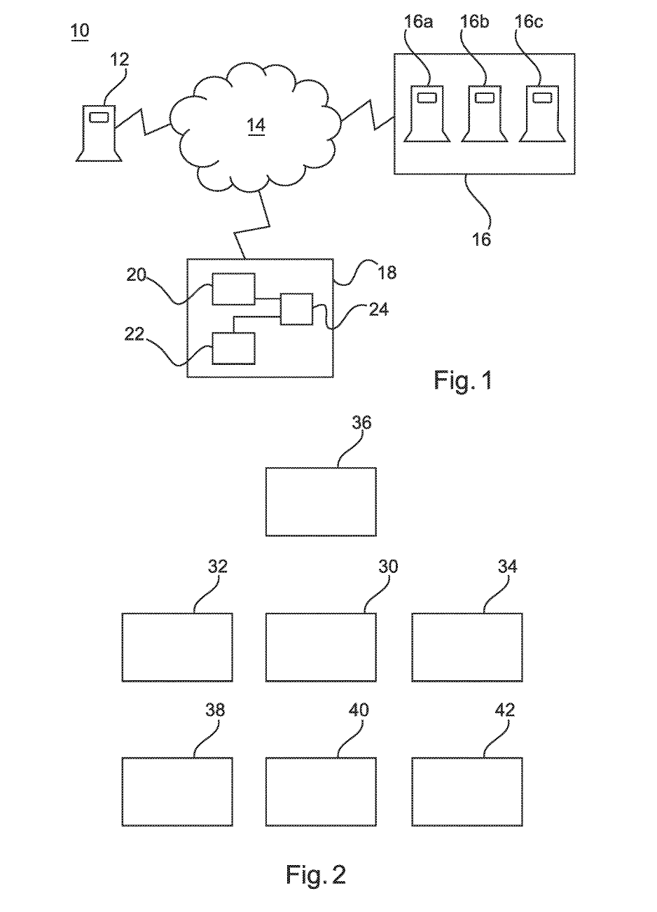

Referring to FIG. 1, there is shown an exemplary system 10 providing mobility assistance according to the methods and systems described herein. The system 10 of FIG. 1 includes a mobility assistant server 12 and a mobility assistant device 18 that are connected over a network 14. The mobility assistant device 18 includes a mobility assistant application 20 that is executed by the device processor 24. The system of FIG. 1 includes information sources 16 comprising a plurality of information servers 16a, 16b, 16c that are connected to the mobility assistant server 12 and/or the mobility assistant device 18 over the network 14. The system 10 operates to analyze a plurality of different transportation options available to a user, based on criteria including at least time, cost, and risk factors. The different transportation options may be obtained from the remote mobility assistant server 12, the mobility assistant device 18 and/or the information sources 16. Further, the criteria may include real-time transportation information obtained from the information sources 16. Based on the analysis, the system 10 generates at least one transportation recommendation and provides an output that includes the recommendation to a user via the mobility assistant device including cost, time and risk metrics specific to the recommendation 18.

The mobility assistant device 18 may be a general-purpose or desktop computer, or may be portable computer device, such as a laptop. The mobility assistant device 18 may be a cellular telephone, smart phone, personal digital assistant, or similar device or an in-vehicle computing device. The mobility assistant device 18 executes a mobility assistant application 20 through the processor 24. The application 20 comprises computer readable instructions stored on non-transitory memory 22. The mobility assistant device 18 may be operated by an end user of the system 10. The mobility assistant application 20 may implement at least some of the modules of FIG. 2 as described further herein.

The mobility assistant server 12 may be implemented by a high-speed computer processing device, such as a mainframe computer or a network of computers including cloud computing resources, or similar type of device capable of handling the volume of activities conducted on behalf of its customers. The mobility assistant server 12 receives requests from mobility assistant devices 18 for transportation recommendations, analyzes transportation options using user preferences and based on cost, time and risk criteria, where the criteria is supported by up-to-date data from the information sources 16. The mobility assistant server 12 includes memory including non-transitory memory, a computer program stored on the non-transitory memory that includes computer readable instructions and a processing device, which operate to execute methods and systems descried herein. The mobility assistant server 12 may include at least some of the modules disclosed in FIG. 2.

The information sources 16 include servers 16a-16c. Each of the servers 16a-16c may be implemented by a high-speed computer processing device, such as a mainframe computer, or similar type of device, and have access to a mass storage device. The servers 16a-16c are configured to perform searches of information stored in the mass storage devices and to provide search results from the searches to requesting entities, such as the mobility assistant server 12 and the mobility assistant devices 18, via one or more of the networks 114. The searches may include requests for current transportation data such as public transportation information including costs, schedules, actual arrival times and the like.

The information servers 16a-16c may represent third-party entities which manage information stored in their corresponding storage devices, and which information is used by the modules shown in FIG. 2 in analyzing transportation possibilities and optionally executing a selected transportation option. The information servers 16a-16c may represent not just sources of information, but also transportation services allowing transportation options to be searched, reserved and bought. In one example, information server 16a may access traffic information for a geographic region that is continuously updated over time. Information server 16b may access weather data for a geographic region that is updated over time. Information server 16b may store parking information for a geographic region or defined providers which is updated over time to provide up-to-date parking availability. While only three servers 16a-16c are shown and described, it will be understood that any number of information sources 16 may be incorporated and accessed by the mobility assistant systems and methods described herein. The servers 16a-16c are provided for illustrative purposes only and are not to be construed as limiting in scope.

It is envisaged that the sources 16 of information may include a ride sharing or ride hire server providing data on ride sharing or ride hire vehicles, a taxi server providing data on taxis, a railway server providing data on railway services, an underground train server providing information on underground trains, a public bus server providing data on public buses, a private bus server providing information on private buses, tram, monorail, shuttle and other communal transportation servers providing corresponding information thereon, a ride share server providing information on rideshares, a rental vehicle server including information on rentals, a bike rental server providing data on bike rentals (and so on), and any combination thereof. The sources 16 of information are frequently updated to ensure up-to-date information is provided to the mobile assistant server 12 and the mobile assistant device 18.

In an embodiment, the network 114 may include any type of network, such as Internet, cellular networks, satellite networks, terrestrial networks, and the like.

FIG. 2 shows a diagram of exemplary modules for implementing the systems and methods described herein relating to analyzing transportation options and recommending at least one transportation option, which may be a multi-modal transportation option. The modules shown in FIG. 2 may be implemented through the mobility assistant server 12 or the mobility assistant device 18 or a combination thereof and optionally also through the information servers 16a to 16c. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. In particular, the modules described herein include at least one processor, a memory and computer program instructions stored on the memory for implementing the various functions and processes described with respect to the modules. Although separate modules are described herein, this does not exclude an integrated topology.

FIG. 2 shows exemplary modules including a travel requirement module 36, a preference module 32, an analyzer module 30, an output module 34, an environment module 38, a transportation modality module and an execution module.

The travel requirement module 36 receives a travel requirement request. The travel requirement module 36 may include a data receiver for receiving data entered by a user or for receiving data from another application as a travel requirement input. The travel requirement module 36 may include a data processor for formulating the travel requirement request from the travel requirement input. The travel requirement module 36 may include a data output interface for communicating the travel requirement request to one or more other modules described herein. The travel requirement request may include a destination and a time. The travel requirement request does not need to include a specification of any transportation modality. The travel requirement request may be entered by a user through the mobility assistant device 18, such as through a user interface thereof (e.g. touchscreen, keyboard, mouse, touchpad, voice recognition, and the like). Alternatively, the travel requirement request may be derived in an automated way from another application such as an appointments application, calendar or electronic mail application, which may be running on the mobility assistant device 18.

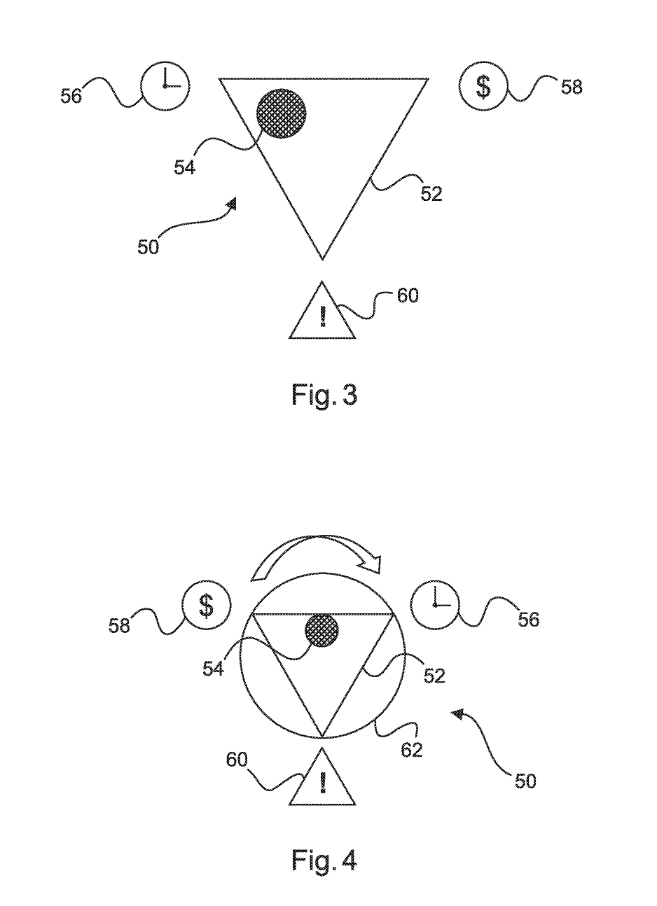

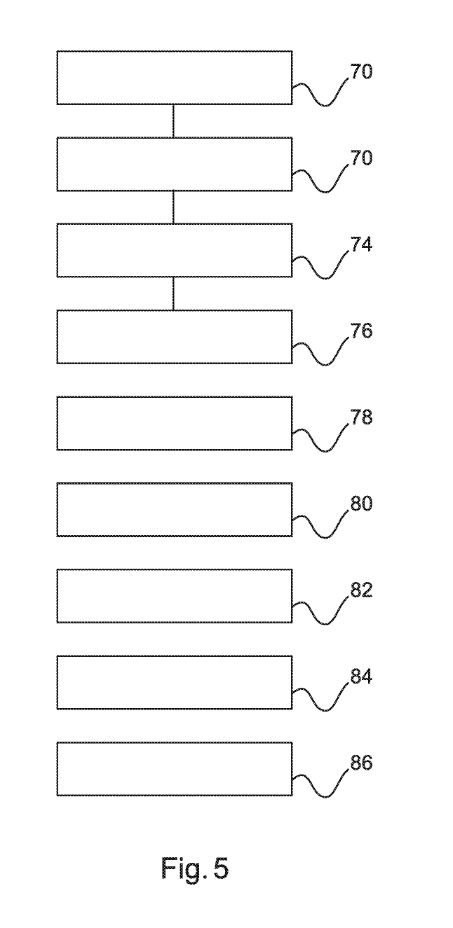

The preference module 32 sets preferences, e.g. user preferences, for use by the analyzer module 30. The preference module 32 may include a data receiver for receiving preference data as an input from a user. The data receiver may also be in communication with memory 22 of the mobility assistant device 18 and memory of the mobility assistant server 12 for accessing previously stored user preferences. The data receiver may be in communication with the user interfaces 50 of FIGS. 3 and 4 to receive user preferences as entered by a user. The preference module 32 may include a processor for processing the received user preferences. Further, the preference module 32 may include a data output interface for communicating the user preferences to one or more other modules as described herein. The preferences may set conditions for an analysis on transportation options by the analyzer module 30. The preferences may include a weighting of time, cost and risk criteria to be taken into account in the analysis. Other user settable preferences include pollution exposure (e.g. favor transportation options or route with the best air quality), Eco-logical impact (Minimize CO2, NOx emitted, petroleum burned, and so on), fitness goals (e.g. favor cycling and walking and running routes, favor routes to obtain a target number of steps or heartbeats, and so on), willingness to cycle and/or walk, maximum cycling and/or walking distance, weather impact on a particular transportation mode (e.g. avoid driving in ice/snow, avoid walking/cycling in precipitation conditions), electronic vehicle mile efficiency (routing to maximize battery pack's range), social/traffic impact (routing to avoid worsening congestion), prefer or avoid curvy roads, routes with best scenery, route with best internet connectivity, route with best lighting, route to maximize personal safety (e.g. avoid dangerous areas), maximize route smoothness, weather preference, or the like, and any combination thereof. These options are human preferences, not necessarily related to the optimal transportation route based on arrival time and cost criteria. Other user preferences that may be set are time of day/week/month/year user preferences. For example, a user may elect to take a longer, low traffic route on the way home from work or prefer greater walking or cycling influence on the way home from work.

Further user preferences may include wherein the criteria is associated with any or all of the following considerations : speed of travel; elapsed travel time; time of day; trip cost; cost incentives; revenues; passenger comfort; passenger amenities; certainty of arrival time; passenger privacy; safety; weather; passenger pickup time; passenger arrival time; potential pollution exposure; potential ecological impact; passenger fitness goals; electric or hybrid vehicle efficiency; gas mileage; social or traffic impact; potentially scenic route; neighborhood safety ratings; lighting conditions; cellular/data connectivity; parking availability; road conditions; walkability/bike ability scores; construction activity; traffic congestion; availability of alternate transit modes (bike share, scooter share,); traffic accident history; and other environmental aspects that may be important to a traveler.

An example of the aforementioned user preferences in more detail is to favor cycling or walking routes at least part of the way when a periodic fitness goal has not yet been completed. Cycling routes may be enabled for routes home after work, but not before work. Maximum walking and cycling distances/times may be set. Further, cycling and walking transportation options may be disabled when there is a likelihood of precipitation.

These user preferences may be adjustable using a user interface of the mobility assistant device 18. The mobility assistant device can include any input device for entering data including user preferences such as touchscreen, keyboard, mouse, voice recognized entry, and the like. User preferences when adjusted may be stored in the memory 22 of the mobility assistant device 18 and/or in a memory of the mobility assistant server 12 as part of a user profile for retrieval for analysis by the analyzer module 30.

Exemplary user interfaces 50, displayed through a display unit of the mobility assistant device 18, are shown in FIGS. 3 and 4. The user interfaces 50 allow a user to select a weighting of time, cost and risk factors for analysis of transportation options through the analyzer module 30.

The user interface 50 of FIG. 3 includes a criteria selection frame in the form of a polygon 52, which is a triangle in this example. Selection within the user interface 50 can occur through keyboard, touch screen, mouse, touchpad and other such input devices. The polygon 52 is associated with a reference marker 54, which is a bubble in the shown example. The user interface 50 further includes time, cost and risk indicators 56, 58, 60 at corners of the polygon 52. The reference marker 54 may be moved by a user relative to the time, cost and risk indicators 56, 58 and 60 through a user interface device, e.g. touchscreen, in order to indicate relative weighting of time, cost and risk. Should the reference marker 54 be at one of the corners, then the associated criteria, e.g. time, will be favored above the other criteria in analysis performed by the analyzer module. Should the reference marker 54 be in between two corners, then the two criteria of the adjacent corners will be favored or weighted more heavily in analysis performed by the analyzer module 30. Should an equal weighting of criteria be preferred, the reference marker 54 can be located in a center of the polygon 52. The user interface 50 can include virtual detents to assist placement of the reference marker 54 at one of a plurality of positions indicating different relative weighting of the criteria.

In the exemplary user interface 50 of FIG. 4, the reference marker 54 is fixed, and the indicators 56, 58 and 60 are rotatable through a virtual wheel 62. Depending upon the user selection through the user interface 50, route options are favored in the analysis module having low time, cost and/or risk and according to the selected weighting.

Although the user interfaces 50 of FIGS. 3 and 4 have been described with reference to time, cost and risk, the user interface could be adapted to include further or alternative user settable criteria including the user preferences described above. For example, the risk indicator 60 could be replaced by fitness goals or ecological factors to allow a user to weight these criteria as desired. Further, alternative shapes for the criteria selection frame could be used including triangles, squares, pentagons, and do so on. Yet further, three-dimensional polygons are possible including pyramid and cube, and the like. Where further user selectable criteria than the shown three are desired, a shaped with a suitable number of sides can be utilized.

The criteria selection frame 52 can be color coded and/or shaded to indicate varying degree/priority of criteria selection. For example, each corner can be associated with a different color and each line connecting the corners can be associated with a mix of the colors of the connected corners. When the reference marker 54 is associated with a particular part of the frame 52, the frame and/or the reference marker can change to the associated color.

The environment module 38 accesses environmental information as most recently updated. The environment module 38 may include a network data interface for receiving environment data over the network 14, such as from the information sources 16. In this way, weather, traffic, construction, and other such environmental data can be received. The environmental module 38 may also include a global positioning data interface for receiving data from a global positioning device of the mobility assistance device 18. The environmental module 38 may include a processor for coordinating requests for environmental data, receiving the environmental data and preparing the environmental data for output. Further, the environment module 38 may include a data output interface for communicating environmental data to one or more other modules described herein. The environmental module 38 may be responsive to geographical information either related to the current location, the destination location (as set by the travel requirement request) and/or one or more routes between the current and destination location. The current location can be determined in a number of ways including a global positioning module of the mobility assistant device 18. The environmental information may include geographically relevant traffic congestion information (including low traffic and congested traffic information) and geographically relevant weather information. The geographical relevance is based on the geographical information. The environmental information may be obtained by the environmental module 38 from the information sources 16.

The transportation modality module 40 provides a list of possible transportation modes and associated time, cost and risk metrics for use by the analyzer module 30. The transportation modality module 40 may include a network data interface for receiving transportation mode data and associated metrics over the network 14, for example from the information sources 16. The transportation modality module 40 may include a processor for coordinating the receipt of data, filtering and otherwise processing the received data. The transportation modality module 40 may include a data output interface that operates with the processor to provide transportation mode data and associated metrics to one or more other modules as described herein. The analyzer module 30 may exclude some of the available transportation modes based on user preferences as received through the preference module 32. The associated metrics can include at least one of scheduling information (e.g. for public transport possibilities), cost, availability, on-time performance and any combination thereof. The availability information can include whether there are any transportation units that are available (such as a rental vehicle) and whether such units are accessible to the particular end user (e.g. where subscription or membership is required). The associated metrics for use in analyzing the possible transportation modes can be ascertained from the information sources 16. The possible transportation modes can include ride sharing or ride hire vehicles, taxis, trains including underground, overground, city, regional, national, and international trains, public buses, private buses, tram, monorail, shuttle and other communal transportation possibilities, rideshares, vehicle rentals, bike rentals, air travel, sea travel, and any combination thereof.

The analyzer module 30 takes as inputs user preferences from the preferences module 32 including time, cost and risk relative weight information, transportation mode possibilities from the transportation modality module 40 including analysis metrics associated therewith, global positioning data, and the travel requirement request from the travel requirement module 36. The analyzer module 30 may include a processor that executes machine readable instructions for running an analysis engine for performing the analysis described in greater detail below. The analyzer module 30 further includes at least one data receiver for receiving input data from various modules as described in the foregoing. Further, the analyzer module may include a data output interface for providing an output concerning at least one travel recommendation to one or more other modules as described herein. The analyzer module 30 performs data analysis and route/mode planning analysis based on the inputs to determine at least one travel itinerary that fits the user preferences, meets the travel requirement request and is optimal in terms of minimizing cost, time and/or risk as per the user's preference. The analyzer module 30 takes into account the environmental information to ensure that any congestion or delays in each modality is factored in based on up-to-date information and also by ensuring that forecast weather data is checked for suitability of travel with a particular mode of transport (e.g. so that walking or cycling in rain is avoided). Yet further, the metrics from the transportation modality module 40 can indicate not only travel time, but also scheduling information, which can be built in to the determined travel itinerary.

The analysis engine of the analyzer module 30 could also provide metrics relative to environmental information as has been described above (such as number of calories burned, number of greenhouse gas units avoided, number of electric vehicle miles of range added by a particular route, etc.). Further, the analysis engine may also calculate after a journey has been completed how much time has been saved via a specific recommendation over another recommendation.

The travel itinerary may include a plurality of transportation modes, and thus can be referred to as a multi-modal route. For example, a combination of bike and train may be determined upon by the analyzer module 30. Even more complex combinations of travel modalities are envisaged, such as bicycle, train, shuttle, and rental vehicle, for example. The travel itinerary as output by the analyzer module 30 can define the modes of transport for the route, the order of the modes of transport, a route for each mode, start and end points for each mode, start time and end time for each mode, and duration of travel for each mode. Plural travel itineraries may be determined upon by the analyzer module 30 to allow for user selection of a preferred course.

The analyzer module 30 is configured to select combinations of transportation modes as well as to determine routes from a range of possible routes within a particular transportation mode. The analyzer module 30 may run a route finding algorithm for a range of different combinations of transportation modes to determine a recommended transportation option.

It is envisaged that the analyzer module 30 will analyze all conceivable combinations of transportation options that are not excluded by user preferences. The possible transportation modes are machine generated based on location data and data from information sources 16 and obtained through the transportation modality module. In this way, the present disclosure focuses on the outcome meeting set criteria, rather than being transportation mode biased like in prior art application where a user selects the preferred transportation mode. The analyzer module 30 is inherently unbiased to any particular transportation mode allowed by user preferences and thus determines at least one recommended travel option that best fits the criteria (e.g. cost, time and risk), user preferences and the destination location and time. That is, the analysis engine is unbiased in that it is free to combine all modes of transportation, in the absence of user preferences to the contrary, and to assess them objectively with respect to analysis criteria provided by the inputs and to determine whichever combination has a highest rating based on the analysis.

The analyzer module 30 aims to meet cost, time and risk criteria, which may be set by user preference. The cost for travelling in a vehicle may include fuel cost and optionally also insurance per mile, parking, depreciation per mile, maintenance cost per mile, for example. The cost may also include any potential profit in making the trip through a certain route due to income opportunities such as package delivery. The cost can include rental costs, ticket costs any other monetary cost associated with a particular transportation option. The time includes calculated time to reach the destination, which may take into account forecast traffic and weather conditions obtained through the environment module 38. The risk can include at least one or a composite of probability of delay, probability of on-time arrival, a security index (e.g. based on crime data) and accident history (e.g. traffic accident history). The analyzer module 30 may forecast an arrival time based on normal journey times and include a further component of the chance of achieving that arrival time based on historical information. The analysis of the present disclosure allows a user to sacrifice overall cost and/or time when minimizing the chance of not achieving a forecast arrival time takes on greater priority. The metrics for obtaining the time, cost and risk data can be obtained from the information sources 16 through the transportation modality module 40. Risk may be a composite (optionally a variably weighted composite) of certainty of arrival time and route safety in terms of safety from crime and/or safety from accidents. The risk factor is based on a collation of historic data that can provide a probabilistic measure of risk, whether that be safety risk or chance of arriving on time or chance of delay. The risk factor can be obtained from metrics provided by the transportation modality module 40.

The output module 34 may output to a display unit of the mobility assistant device 18 (e.g. a smartphone display unit), a summary of the optimal travel itinerary as selected by the analyzer module 30 and optionally at least one further travel itinerary corresponding to the second best, third best (and so on) multi-modal routes according to the analysis performed by the analyzer module 30. The output module 34 may include a data receiver for receiving output data from the analyzer module 30 regarding at least one recommended transportation option or itinerary. The output module 34 may include a processor executing instructions for collating the data. The output module 34 may include a display generator operating with the processor that generates a graphical user interface for displaying the at least one recommended transportation option. Further, the output module 34 may include a communications interface with the execution module 42 described below to allow adaptive, e.g. location adaptive, display generation. The output module 34 may output an indication of the transport modes (e.g. in the form of an icon) and the start time and location for each transport mode. The output module 34 may invite the user to select the preferred travel itinerary from the presented options if more than one option is presented. During the selected route being traversed by the user, map and other detailed information concerning the route and particularly the transition between modes of transport can be displayed.

The execution module 42 manages transactional aspects of a selected travel itinerary. The execution module 42 may include a global positioning device interface for receiving global positioning data. Further, the execution module may include a processor that executes navigation software to allow adaptive navigation along the selected travel itinerary, e.g. along a map associated with the selected travel itinerary. The execution module 42 may include an output data interface in communication with the output module 34 so that the displayed output is adaptive to execution processing including adaptive navigation display, adaptive display of instructions depending on location and possible display of a re-route as described in further detail below. For example, reservations can be made for each transport mode where required, any payment required can be made, navigation along the route can be implemented for use by the output module 34 to display the route and any details required in order to access a transportation mode (e.g. vehicle rental details), and the like. The execution module 42 may also manage receipt of payment and conduct of any possible income along a selected route, such as delivery of a package.

The execution module 42 and the output module 32 may offer more detailed guidance concerning a particular route depending on familiarity of a user with the current route. For example, if unfamiliar transportation modalities or unfamiliar locations are included in the route, then further details may be provided to a user. By contrast, familiar routes, such as a daily commute, may include little direction and operate on an exception to the norm basis. For example, the execution module may define plural level of familiarity, such as three or more levels, including familiar (e.g. daily commute), medium level of familiarity (e.g. new location in home city) and unfamiliar (new city or country). The level of guidance detail provided is adapted based on level of familiarity.

The execution module 42 may communicate with the environment module 38 and/or the information sources 16 during a selected route being traversed in order to monitor whether the route remains the optimal route. Should environmental conditions changes, such as due to a traffic accident, a dynamic plan B request can be sent to the analyzer module 30 to calculate at least one new travel option.

FIG. 3 shows a flowchart illustrating steps of exemplary methods according to the present disclosure. The method steps may be executed by modules as shown in FIG. 2, which may be distributed between the mobility assistant server 12 and the mobility assistant device 18 and optionally also the information sources 16.

In step 70, a travel requirement request is received by the system 10, specifically the travel requirement module 36. The travel requirement request may include at least one destination location and a target time of arrival. The destination address may be a city, a point of interest, a specific address, a zip code, etc. and may include plural destinations. The travel requirement request may be derived from an external application running on the mobility assistant device 18. Alternatively, the travel requirement request may be entered by a user through the mobility assistant device 18.

In step 72, user preferences are obtained through the preferences module 32. The user preferences may be retrieved from memory, such as from a user profile in memory 22 of mobility assistant device 18 or from a memory of the mobility assistant server 12, and may be adjusted by user entry through the mobility assistant device 18. The user preferences obtained from step 72 concern human factors such as any weather dependency on cycling and walking options, the priority of any fitness goals, the priority of avoiding traffic, or preferred transport modalities, priority of ecofriendly options, preference as to scenic routes or internet connected routes, priority of good lighting along route, priority of avoiding pollution areas, and the like.

In step 74, user preferences relating to time, cost and risk can be retrieved from memory, such as memory 22 of the mobility assistant device 18, or obtained through user entry to the mobility assistant device 18. Step 74 is able to ascertain a relative weighting or importance of time, cost and risk to the user for a particular journey. The user preferences of step 74 may be received by a data receiver of the system 10 optionally via a data input device such as a graphical user interface 50 as shown in FIGS. 3 and 4 or another appropriate user interface or via a data retrieval device from memory such as memory 22 of mobility assistant device 18. Depending upon the user entry, low travel time, low cost and/or low risk may be prioritized in the subsequent analysis performed by step 76.

In step 76, environmental data and transportation modality data are retrieved through the environment module 38 and through the transportation modality module 40. The environmental data and the transportation modality data are current data, persistently updated at the information servers 16a-16c. The environmental data includes weather data, traffic data, construction data and transportation delay data, for example. The transportation data includes available transportation modalities based on the starting location of the user, as determined through global positioning data obtained from the mobility assistant device. The available transportation modalities can include owned transportation, such as a user's vehicle or bicycle, as well as ticketed transportation and transportation available to hire or rent or borrow such as trains, trams, shuttles, buses, rental vehicles, rental bicycles, and so on. The transportation data includes metrics associated with each available transportation modality, where the metrics are related to at least time, cost and risk. The metrics may include schedules (e.g. public transport schedules such as train or bus schedules), travel time, cost (e.g. cost of ticket, or cost per mile (e.g. including fuel and maintenance costs), or cost to rent or hire), on-time performance metrics, personal safety metrics (e.g. indication of assault or robbery or other crime incidents, safety from traffic accidents), current availability of transportation, and the like.

In step 78, an analysis engine is run through the analyzer module 30 to determine upon at least one recommended travel itinerary. The inputs of the travel requirement request from step 70, the user preferences from step 72, the relative weight of time, cost and risk from step 74, the environment data and the transportation modality data from step 76 are analyzed to produce one or more output travel options, which may be in the form of travel itineraries. The output travel options are influenced by the user preferences, meet the travel requirement request, balance time, cost and risk factors as requested by the user and are based on core transportation modality and environmental data. The output travel option(s) may be multi-modal routes in that more than one different transportation modality is encompassed. In fact, more than two, three, four, (or more) transportation modalities may be included.

In step 80, the travel option(s) produced in analysis step 78 can be output to a user so as to summarize the travel plan including start time and location and at each different transportation modality stage. Where more than one travel option has been produced in step 78, the options may be displayed in order of preference as determined by the analyzer module 30.

In step 82, the user is invited to verify the travel option produced in step 78 or to select one of a plurality of proposed travel options. The verification may be entered through the mobility assistant device 18.

In step 84, the selected or verified travel option from step 82 is executed through execution module 42. To do so, the execution module may communicate with information sources 16 or with other third party servers over the network 14. The execution step 82 may include reservation of a transportation mode, such as a rideshare, rental vehicle, communal bicycle, train seat, and so on. Further, the execution step performs any necessary transactions such as payment for travel tickets, payment for rental, electronic unlocking of doors, turning on of the vehicle or electronic release of a transportation item (such as a communal bike that is electronically unlocked), by way of example The execution step also makes available for output details of the transactions and any instructions required, such as instructions for obtaining a rental vehicle. Further, the execution step 84, collates navigation and detailed instructions for output to the user. Any alerts or automated release of a transportation mode is also readied in the execution step.

In step 86, the execution module 42 and the output module 34 work together to provide navigation instructions as the user traverses the route. For example, the navigation instructions may include map navigation and optionally also voice directions. Further, detailed directions at transitions between transportation modes can be provided to the user through a display or through voice directions or both. Any directions required for manual release of a transport mode are also provided to the user. The instructions provided to the user in step 86 are timed based on global positioning data so that the appropriate instructions are provided at the correct location along the route.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
analyzing, via a processor, a plurality of different transportation options available to a user based on criteria related to time, cost, and risk factors;
generating, via a processor, at least one transportation recommendation based on the analyzing; and
providing, via a processor, an output that includes the at least one transportation recommendation to a user electronic device.

2. The method of claim 1, wherein the analyzing comprises taking into account user preferences relating to priority of time, cost and risk.

3. The method of claim 1, wherein risk relates to a certainty of arrival time and route safety in terms of safety from crime and/or safety from accidents or a composite thereof.

4. The method of claim 1, wherein the analyzing step is unbiased to any particular transportation mode in the absence of set user preferences to the contrary.

5. The method of claim 1, wherein the transportation recommendations favor certain user-defined transportation modes in accordance with a user's set preferences.

6. The method of claim 1, comprising assessing, via a processor, a level of familiarity to a user of a selected transportation recommendation and adapting a level of detail of guidance provided to the user based on the level of familiarity.

7. The method of claim 1, wherein the plurality of different transportation options include transportation options owned by a user, personal transportation options accessible by a user and communal transportation options accessible by a user and the analyzing step comprises analyzing each combination of the different transportation options.

8. The method of claim 1, further comprising:
receiving at least one travel mode selected from the transportation recommendations; and
initiating a reservation, ticketing, dispatching, renting, hiring or purchasing, related to the selected travel mode.

9. The method of claim 1, wherein the transportation recommendations accommodate a multi-modal transportation option that includes a plurality of different transportation modes.

10. The method of claim 1, further comprising:
presenting a selector user interface that allows the user to indicate which trip attributes or criteria are prioritized for a particular trip.

11. The method of claim 10, wherein the selector comprises a time priority indicator, a cost priority indicator, and a safety/risk priority indicator.

12. A system for providing at least one transportation recommendation, the system comprising:
modules operating on at least one of a mobility assistant server and a mobility assistant device, wherein the modules comprise:
a travel requirement module for receiving a travel requirement request for a user of the mobility assistant device, wherein the travel requirement request comprises at least one destination location;
a transportation modality module configured to generate available transportation modes based at least on a location of the user and configured to retrieve metrics relating at least to time, cost and risk of each available transportation mode;
an analyzer module configured to analyze the available transportation modes and the associated metrics based on criteria related to time, cost, and risk factors to determine at least one transportation recommendation; and
an output module configured to output the at least one transportation recommendation to a user electronic device.

13. The system of claim 12, wherein the travel requirement module is configured to access information sources over a network to generate the available transportation modes and to retrieve the associated metrics.

14. The system of claim 12, comprising an execution module configured to execute payment, reservation or other transactions associated with a transportation recommendation.

15. The system of claim 12, comprising a user preferences module configured to set a weighting of priority of time, cost and risk according to user preference.

16. A computer-readable medium comprising processor-executable instructions configured to be executed by a processor to perform the steps of:
generating available transportation modes based at least on location data of a user;
retrieving metrics relating at least to time, cost and risk of each available transportation mode;
analyzing the available transportation modes and the associated metrics based on criteria related to time, cost, and risk factors;
determining at least one transportation recommendation based on the analyzing; and
outputting the at least one transportation recommendation to a user electronic device.

17. The computer readable medium of claim 16, wherein the processor-executable instructions are configured to be executed by a processor to perform the step of obtaining user preferences relating to at least one of potential pollution exposure; potential ecological impact; fitness goals; electric or hybrid vehicle efficiency; traffic impact; potentially scenic route; cellular/data connectivity; environmental aspects; smoothness of ride; willingness to walk; willingness to cycle.

18. The computer readable medium of claim 16, wherein the processor-executable instructions are configured to be executed by a processor to perform the step of obtaining user preferences relating to a relative weight of the time, cost and risk factors to be used in the analyzing step.

19. The computer readable medium of claim 16, wherein the processor-executable instructions are configured to be executed by a processor to perform the step of executing a selected travel recommendation by performing at least one of initiating a reservation, ticketing, renting, purchasing, or other action.

20. The computer readable medium of claim 16, wherein the computer-readable medium comprises processor-executable instructions configured to be executed by the processor to perform the step of determining at least one transportation recommendation based on the analyzing by determining at least one transportation recommendation comprising a plurality of different transportation modes.
